(19) United States
(12) Patent Application Publication
(10) Pub. No.: US 2007/0033680 A1
(43) Pub. Date: Feb. 8, 2007

(54) Optical inspection system and its illumination method

(76) Inventor: Tetsuo Takahashi, Tokyo (JP)

Correspondence Address: CHRISTIE, PARKER & HALE, LLP, PO BOX 7068, PASADENA, CA, 91109-7068, US

(21) Appl. No.: 11/486,594

(22) Filed: Jul. 13, 2006

(30) Foreign Application Priority Data
Jul. 20, 2005 (JP) 2005-209865

(51) Int. Cl. G21K 7/00

(52) U.S. Cl. 977/869

(57) ABSTRACT

An optical inspection system provided with a light source, object lens, illumination optical system emitting illumination light generated from the light source through an object lens to a sample, and imaging optical system forming an image of the sample projected by the object lens, the optical inspection system further provided with an imaging optical system magnification changer for changing the magnification of the imaging optical system and an illumination light cross-sectional dimension changer provided at the illumination optical system and changing the cross-sectional dimensions of the illumination light emitted to the sample in accordance with the magnification of the imaging optical system.

### BACKGROUND OF THE INVENTION

1. Field of the Invention

The present invention relates to an optical inspection system and illumination method used for inspection of wafers, masks, and other semiconductor materials, more particularly relates to an optical inspection system and illumination method using deep ultraviolet light as illumination light.

2. Description of the Related Art

In a semiconductor wafer, semiconductor memory photomask, liquid crystal display panel, etc., predetermined patterns are repeatedly formed. Accordingly, optical images of the patterns are captured and adjoining patterns are compared so as to detect any pattern defects. If the result of a comparison is that there is no difference between two patterns, it is judged that the patterns have no defects, while if the result is that there is a difference, it is judged that there is a defect in one of the patterns. In such a semiconductor wafer inspection system, in general an optical microscope is used for capturing optical images of the patterns.

FIG. 12 is a view of the schematic configuration of a conventional optical inspection system. As illustrated, this is provided with a stage 16 holding a sample 15, a light source 11 for illuminating the sample 15, an object lens 14 for projecting an optical image of the surface of the sample 15, an illumination optical system 12 for emitting illumination light generated from the light source 11 through the object lens 14 to the sample 15, an imaging optical system 18 for forming the image of the sample 15 projected by the object lens 14, a beam splitter 13 for reflecting illumination light incoming it from the illumination optical system 12 to the object lens 14 and passing projected light of the image of the sample 15 from the object lens 14 to the imaging optical system 18, and an imaging device 19 for converting the optical image of the surface of the sample 15 projected by the imaging optical system 18 to an electrical image signal.

The illumination optical system 12 is provided with a collector lens 21 for gathering light from the light source 11 and creating an image of the light source of a uniform brightness at a back focal position, a field aperture 31 provided at a back focal position of the collector lens 21, a condenser lens 40 for forming a aerial image of the field aperture 31 at the rear side, and a relay lens 22 for projecting a aerial image of the field aperture 31 formed at the rear side of the condenser lens 40 infinitely far. The aerial image of the field aperture 31 projected infinitely far by the relay lens 22 is reflected by the beam splitter 13 to the object lens 14, then is focused by the object lens 14 at the sample 15, whereby the sample 15 is illuminated by light of a uniform brightness. On the other hand, the imaging optical system 18 is provided with an imaging lens 50 for forming an image of the sample 15 projected by the object lens 14 on an image sensor 19.

Along with the recent increasing fineness of the pattern rule, the optical microscopes used for semiconductor wafer inspection systems have been required to capture higher resolution images, for this reason, shorter wavelength light sources and higher performance image processing system higher in performance are used in such optical microscopes. Already, optical inspection systems using deep ultraviolet light having a wavelength of 270 nm or less for the illumination light are being produced.

Further, in semiconductor wafer inspection systems, it would be desirable to change the observation magnification of optical microscopes in accordance with the type of the pattern region being observed. For example, in the memory cell area formed on a semiconductor wafer, the patterns formed are fine. To discover fine defects, it is necessary to raise the observation magnification for observation. As opposed to this, in the logic region or peripheral region, the patterns formed are not as fine as the memory cell area, so it is more efficient to lower the observation magnification. As techniques for changing the observation magnification, there are the technique of switching the magnification of the object lens of the optical microscope and the technique of switching the magnification of the imaging lens for forming an image of the inspected object projected by the object lens. Among these, the technique of switching the magnification of the imaging lens does not require provision of an object lens for each magnification and does not require movement of the object lens, so the reproducibility of the optical axis is easily obtained. For this reason, particularly, in an inspection system using deep ultraviolet light requiring an expensive object lens and high precision adjustment, the technique of switching the imaging lens is preferably used.

Note that in the above explanation, a semiconductor wafer inspection system was particularly explained, but the present invention is not limited to a semiconductor wafer inspection system and can also be applied to an optical microscope or other optical inspection system.

However, if changing the observation magnification at the imaging lens side, only the field of observation becomes narrower. The illumination range of the illumination light emitted to the sample does not change. Therefore, there are the problems that the amount of light led to the imaging device 19 or other detector is reduced and further a wasted region outside the field of observation is illuminated. Particularly, in an inspection system using deep ultraviolet light, the resist coated on a sample during the semiconductor production process is damaged, so it is necessary to avoid emission of unnecessary deep ultraviolet light.

### SUMMARY OF THE INVENTION

An object of the present invention is to provide an optical inspection system not illuminating any wasted region outside the field of observation even if changing the observation magnification and able to prevent any drop in the amount of light led to a detector for detecting a captured optical image and an illumination method for the same.

To achieve the above object, in the optical inspection system and its illumination method according to the present invention, the cross-sectional dimensions of the illumination light in an illumination optical system are changed in accordance with the magnification of the imaging optical system to expand or contract the range of illumination on a sample.

That is, according to a first aspect of the present invention, there is provided an optical inspection system provided with a light source, an object lens, an illumination optical system for emitting illumination light generated from a light source through the object lens onto a sample, and an imaging optical system for forming an image of a sample projected by the object lens and further provided with an imaging optical system magnification changer which changes the magnification of the imaging optical system and an illumination light cross-sectional dimension changer provided at the illumination optical system and changing the cross-sectional dimensions of the illumination light emitted to the sample in accordance with the magnification of the imaging optical system.

By providing this illumination light cross-sectional dimension changer, the problem of illuminating a wasted region outside of the field of observation is solved and damage to a sample can be prevented particularly in an inspection system using deep ultraviolet light. The illumination light cross-sectional dimension changer may be provided with for example a field aperture provided at the illumination optical system and change the aperture dimensions of the field aperture so as to change the cross-sectional dimensions of the illumination light.

The illumination optical system may be provided with a condenser lens for gathering the illumination light from the light source and forming an image of the light source on the pupil plane of the object lens, and the illumination light cross-sectional dimension changer may change the magnification of the condenser lens to change the cross-sectional dimensions of the illumination light. Further, the illumination optical system may be provided with a condenser lens for gathering the illumination light from the light source and forming an image of the light source on the pupil plane of the object lens, and the illumination light cross-sectional dimension changer may be provided with a relay optical system arranged between the light source and the condenser lens and change the magnification of the relay optical system to change the cross-sectional dimensions of the illumination light. Further, the illumination light cross-sectional dimension changer may be provided with a fly-eye lens provided at the illumination optical system and change the magnification of the fly-eye lens to change the cross-sectional dimensions of the illumination light. If changing the magnification of the optical system for gathering the illumination light from the light source in this way to change the cross-sectional dimensions of the illumination light emitted to the sample, it becomes possible to hold constant the amount of light emitted to the illumination range of the illumination light.

Further, the illumination optical system may be provided with a condenser lens for gathering illumination light from the light source to form an image of the light source on the pupil plane of the object lens and an illumination numerical aperture changer which changes the cross-sectional dimensions of the illumination light incoming the condenser lens to change the illumination numerical aperture, the illumination light cross-sectional dimension changer may be provided with a fly-eye lens arranged between the light source and condenser lens and change the magnification of the fly-eye lens to change the cross-sectional dimensions of the illumination light, and the illumination numerical aperture changer may be provided with a relay optical system arranged between the light source and fly-eye lens and change the magnification of the relay optical system to change the illumination numerical aperture. By combining the fly-eye lens and relay optical system able to be switched or changed in magnification, as explained later, it becomes possible to adjust the numerical aperture (NA) of the illumination independent from the cross-sectional dimensions of the illumination light.

Further, the illumination method of the optical inspection system according to the second aspect of the present invention is an illumination method of an optical inspection system provided with a light source, object lens, illumination optical system emitting illumination light generated from a light source through an object lens to the sample, and imaging optical system for forming an image of the sample projected by the object lens, which changes the cross-sectional dimensions of the illumination light in an illumination optical system in accordance with the magnification of the imaging optical system so as to adjust the illumination range on the sample. The cross-sectional dimensions of the illumination light may be changed by, for example, providing a field aperture of the illumination optical system and changing the aperture dimensions of the field aperture.

Further, the illumination optical system may be provided with a condenser lens for gathering the illumination light from the light source to form an image of the light source on the pupil plane of the object lens and change the magnification of the condenser lens so as to change the cross-sectional dimensions of the illumination light. Further, the illumination optical system may be provided with a condenser lens for gathering the illumination light from the light source to form an image of the light source on the pupil plane of the object lens and a relay optical system arranged between the light source and condenser lens and change the magnification of the relay optical system to change the cross-sectional dimensions of the illumination light. Still further, the illumination optical system may be provided with a fly-eye lens and change the magnification of the fly-eye lens so as to change the cross-sectional dimensions of the illumination light.

Further, the illumination optical system may be provided with a condenser lens for gathering the illumination light from the light source to form an image of the light source on the pupil plane of the object lens, a fly-eye lens arranged between a light source and condenser lens, and a relay system arranged between the light source and fly-eye lens and change the magnification of the fly-eye lens so as to change the cross-sectional dimensions of the illumination light and change the magnification of the relay optical system to change the cross-sectional dimensions of the illumination light incoming the condenser lens so as to change the illumination numerical aperture.

According to the present invention, there are provided an optical inspection system and illumination method not illuminating a wasted region outside the field of observation even if changing the observation magnification and able to prevent a drop in the amount of light guided to a detector detecting the captured optical image.

### BRIEF DESCRIPTION OF THE DRAWINGS

These and other objects and features of the present invention will become clearer from the following description of the preferred embodiments given with reference to the attached drawings, wherein:

FIG. 1 is a schematic view of the configuration of an optical inspection system according to a first embodiment of the present invention;

FIG. 2 is a schematic view of the configuration of an imaging lens unit shown in FIG. 1;

FIG. 3 is a schematic view of the configuration of a field aperture mechanism;

FIG. 4 is a schematic view of the configuration of a condenser lens mechanism;

FIG. 5 is a schematic view of the configuration of an optical inspection system according to a second embodiment of the present invention;

FIG. 6 is a schematic view of the configuration of an optical inspection system according to a third embodiment of the present invention;

FIG. 7 is a schematic view of the configuration of an optical inspection system according to a fourth embodiment of the present invention;

FIG. 8 is a schematic view of the configuration of an optical inspection system according to a fifth embodiment of the present invention;

FIG. 9 is a schematic view of the configuration of a fly-eye lens mechanism;

FIG. 10 is a schematic view of the configuration of a beam expander mechanism;

FIG. 11 is a schematic view of the configuration of an optical inspection system according to a sixth embodiment of the present invention; and

FIG. 12 is a schematic view of the configuration of a conventional optical inspection system.

### DESCRIPTION OF THE PREFERRED EMBODIMENTS

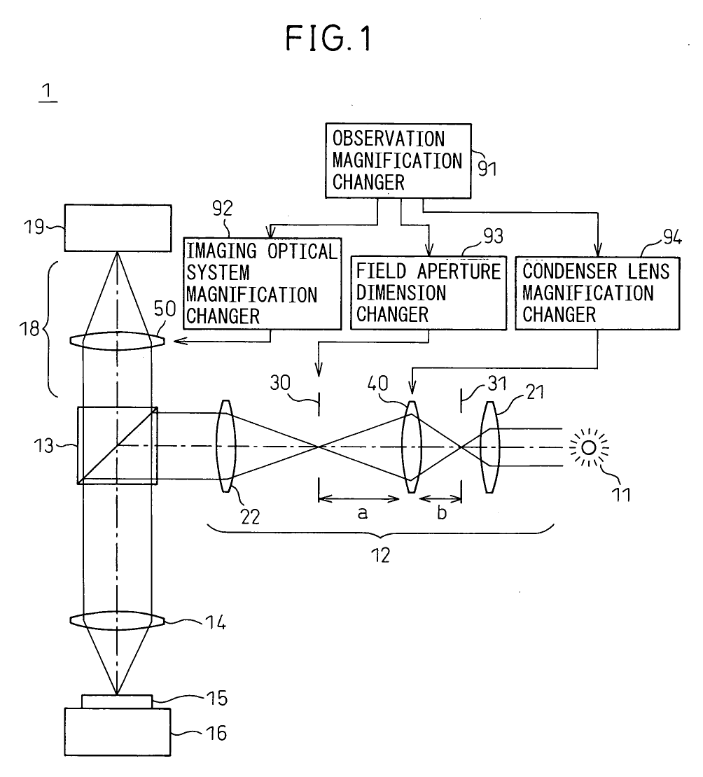

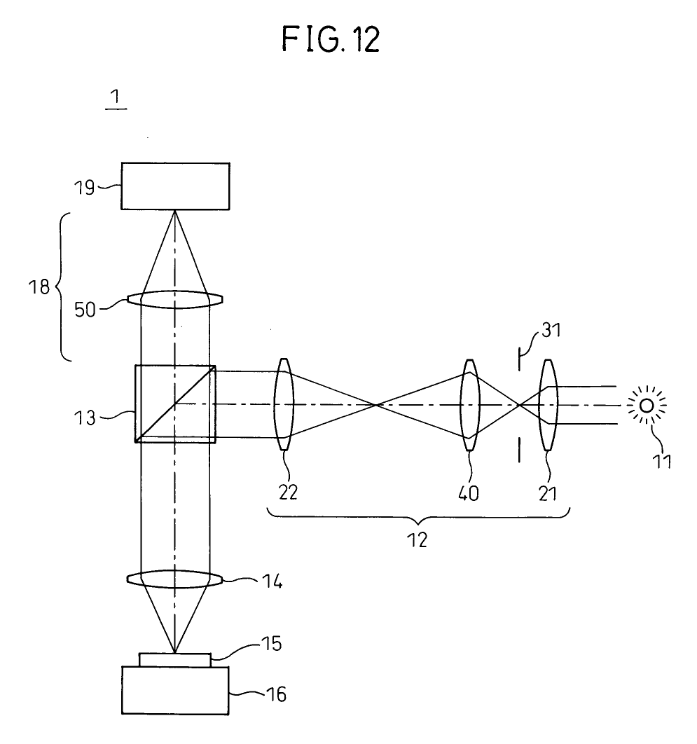

Preferred embodiments of the present invention will be described in detail below while referring to the attached figures. FIG. 1 is a schematic view of the configuration of an optical inspection system according to a first embodiment of the present invention. In the same way as the conventional optical inspection system explained with reference to FIG. 12, the optical inspection system 1 is provided with a stage 16 for holding a sample 15, a light source 11 for illuminating the sample 15, an object lens 14 for projecting an optical image of the surface of the sample 15, an illumination optical system 12 for emitting illumination light generated from the light source 11 through the object lens 14 to the sample 15, an imaging optical system 18 for forming an image of the sample 15 projected by the object lens 14, a beam splitter 13 for reflecting illumination light incoming it from the illumination optical system 12 to the object lens 14 and passing projected light of the image of the sample 15 from the object lens 14 to an imaging optical system 18, and an imaging device 19 for converting an optical image of the surface of the sample 15 projected by the imaging optical system 18 to an electrical image signal. In the following embodiment, as the light source 11, a lamp light source of UV light having a wavelength centered on 365 nm is used, but the present invention is not limited to this. It may also be applied to a light source of any wavelength.

The illumination optical system 12 is provided with a collector lens 21 gathering the light from the light source 11 to create a light source image of a uniform brightness at the back focal position, a field aperture 31 provided at the back focal position of the collector lens 21, a condenser lens 40 forming a aerial image of the field aperture 31 at the rear side, a field aperture 30 provided at the rear side of the condenser lens 40, and a relay lens 22 projecting an image of the field aperture 30 infinitely far. The position of the field aperture 30 becomes the front focal position of the relay lens 22, so the image of the field aperture 30 is projected infinitely far by the relay lens 22, is reflected by the beam splitter 13 to the object lens 14, then is condensed on the sample 15 by the object lens 14, whereby the sample 15 is illuminated by a uniform brightness of illumination light. Here, for example, in the present embodiment, assume that the diameter of the beam formed at the position of the field aperture 31 is 5.6 mm, the focal distance of the object lens 14 is 10 mm, and the focal distance of the relay lens 22 is 500 mm. Therefore, an image of the field aperture 30 is projected by a relay lens 22 and object lens 14 on the surface of the sample 15 by a magnification of 500 mm/10 mm=50×.

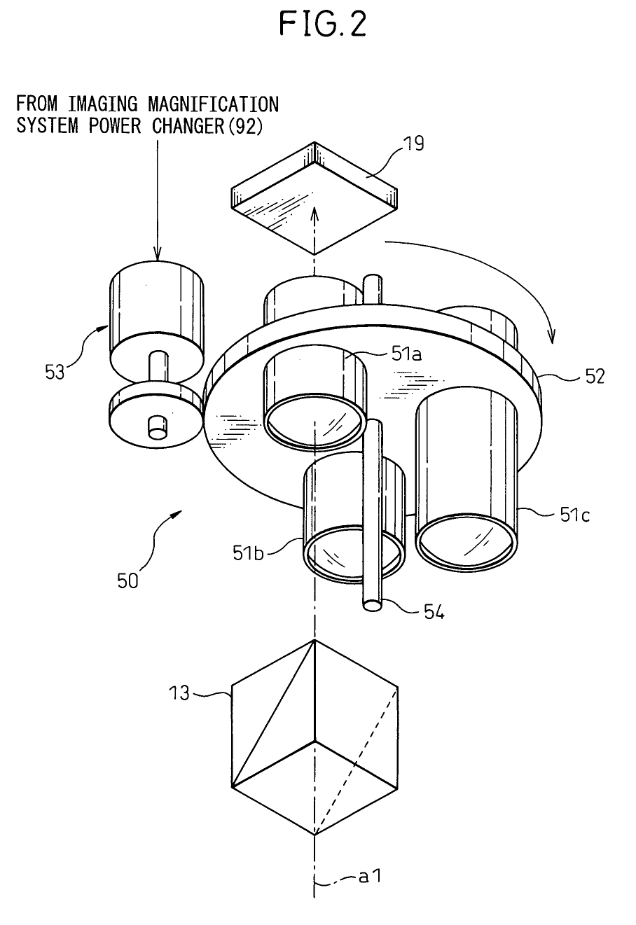

On the other hand, the imaging optical system 18 is provided with an imaging lens unit 50 for forming an image of a sample 15 projected by an object lens 14 on the image sensor 19. FIG. 2 shows the schematic configuration of the imaging lens unit 50. The imaging lens unit 50 is provided with a turret structure provided on a disk 52 able to rotate a lens 51a of a focal distance f=500 mm, a lens 51b of a f=1000 mm, and a lens 51c of f=2000 mm about a shaft 54. The motor 53 is operated to control the rotational position of the disk 52. Due to this, by positioning the desired lens among the lenses 51a to 51c on an optical axis al of the object lens 14, it is possible to switch the focal distance of the imaging lens unit 50 to any of f=500 mm, 1000 mm, and 2000 mm.

Returning to FIG. 1, the optical inspection system 1 is provided with an observation magnification changer 91 for changing the magnification of the imaging optical system 18 to change the observation magnification and an imaging optical system magnification changer 92 for switching the focal distance (magnification) of the imaging lens unit 50 under the control of the observation magnification changer 91. The imaging optical system magnification changer 92 can drive the motor 53 shown in FIG. 2 under the control of the observation magnification changer 91 so as to position the desired lens among the lenses 51a to 51c on the optical axis al of the object lens 14 and thereby switch the focal distance of the imaging lens unit 50 to any of f=500 mm, 1000 mm, and 2000 mm. Here, the observation magnifications when combining the lenses 51a, 51b, and 51c with the object lens 14 become 500 mm/10 mm=50×, 1000 mm/10 mm=100×, and 2000 mm/10 mm=200×, respectively.

As the imaging device 19, a CCD, line sensor, TDI, etc. are suitably used. In the present invention, a TDI sensor is used. By moving the stage 16, the imaging device 19 is made to relatively scan the sample 15. While doing this, the imaging signal is read in synchronization with the movement of the stage 16 to acquire a two-dimensional image of the sample 15. In the present embodiment, the light receiving surface of the TDI sensor used for the imaging device 19 is made a long side of 25 mm×short side of 10 mm and the diagonal length is made 26.93 mm.

If using as an imaging lens a lens 51a having a focal distance f=500 mm, the position of the field aperture 30 and the light receiving surface of the imaging device 19 are equal magnification conjugate planes, so by placing a field aperture having aperture dimensions of substantially the same dimensions as the light receiving surface of the imaging device 19 at the position of the field aperture 30, the sample 15 is also illuminated at only exactly the necessary and sufficient region. At the time of using the other lenses 51b and 51c as well, by inserting the field aperture 30 having the aperture dimensions corresponding to the magnification, the sample 15 is illuminated at only exactly the necessary and sufficient region. Examples of the dimensions of the field aperture 30 are shown in the following Table 1.

TABLE 1

| Focal distance of | Aperture dimensions (mm) of field aperture | |
|---|---|---|
| imaging lens (mm) | Long side | Short side |
| 500 | 26 | 11 |
| 1000 | 13 | 5.5 |
| 2000 | 6.5 | 2.75 |

If using the lens 51a, since light incomes the entire light receiving surface of the imaging device 19, the aperture dimensions of the field aperture 30 should be at the lowest a long side of 25 mm×short side of 10 mm, but the numerical values shown in Table 1 are made numerical values given some leeway considering the fine fluctuations in magnification of the optical system or margin of lens adjustment. The same is true for the lenses 51b and 51c. Returning to FIG. 1, the optical inspection system 1 is provided with a field aperture dimension changer 93 changing the aperture dimensions of the field aperture 30 in accordance with the magnification of the imaging optical system 18 changed by the observation magnification changer 91 (that is, in accordance with which of the imaging lenses 51a to 51c is used).

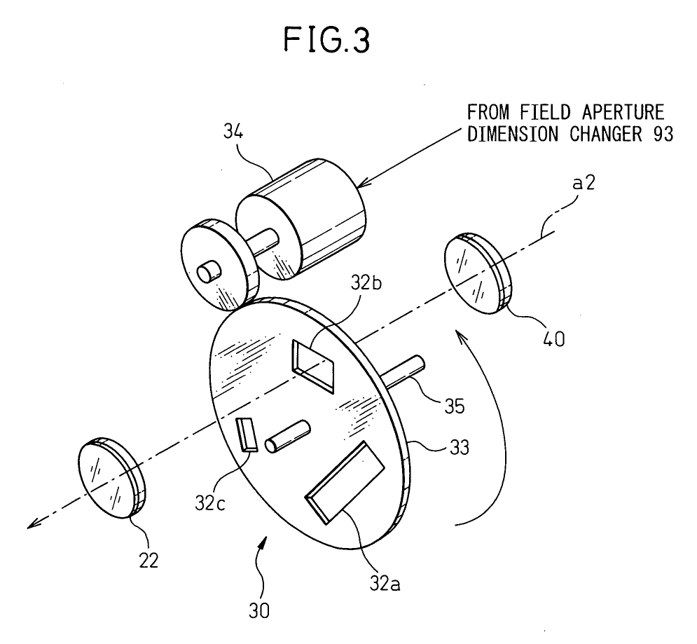

FIG. 3 shows the schematic configuration of the field aperture mechanism 30 for switching the aperture dimensions under the control of the field aperture dimension changer 93. The field aperture mechanism 30 has a disk 33 having aperture parts 32a to 32c of the dimensions specified in the above Table 1 corresponding to the imaging lenses 51a to 51c. Further, the motor 34 is operated to make the disk 33 rotate about a shaft 35. Further, the rotational position of the disk 33 is controlled to position the desired aperture among the aperture parts 32a to 32c on the optical axis a2 of the illumination light so as to switch the aperture dimensions of the field aperture 30. The field aperture dimension changer 93 uses the corresponding aperture parts 32a to 32c as the aperture part of the field aperture in accordance with which of the lenses 51a to 51c of the imaging lens unit 50 is used.

If the aperture dimensions of the field aperture 30 changes (is switched) in accordance with the magnification of the imaging optical system 18, the eclipse of the illumination light by the field aperture 30 is adjusted. Particularly, when making the observation magnification higher, the eclipse of the illumination light is increased and the amount of light detected by the imaging device 19 ends up being reduced. Therefore, the optical inspection system 1 has a condenser lens magnification changer 94 which changes the magnification of the condenser lens 40 in accordance with the magnification of the imaging optical system 18 changed by the observation magnification changer 91 (that is, in accordance with which of the imaging lenses 51a to 51c is used) and changes the magnification of the condenser lens 40 to change the cross-sectional dimensions of the beam of the illumination light at the position of the field aperture 30 at the rear side. If the condenser lens magnification changer 94 makes the cross-sectional dimensions of the beam of the illumination light at the position of the field aperture 30 smaller as the observation magnification becomes higher, the above eclipse is reduced and the amount of light detected at the imaging device 19 is maintained.

The focal distances and the positions of arrangement of the condenser lens 40 used in the case of the magnifications explained in the imaging optical system 18 are shown in the following Table 2. In Table 2, the position of arrangement a shows the distance between the condenser lens 40 and the field aperture 30, while the position of arrangement b shows the distance between the condenser lens 40 and the field aperture 31.

TABLE 2

| | | |
|---|---|---|
| Magnification of | | |
| imaging optical | Focal distance | Placement position (mm) |

| system | (mm) | a | b |
|---|---|---|---|
| 50 | 100 | 600 | 120 |
| 100 | 146.9 | 514.3 | 205.7 |
| 200 | 177.8 | 400 | 320 |

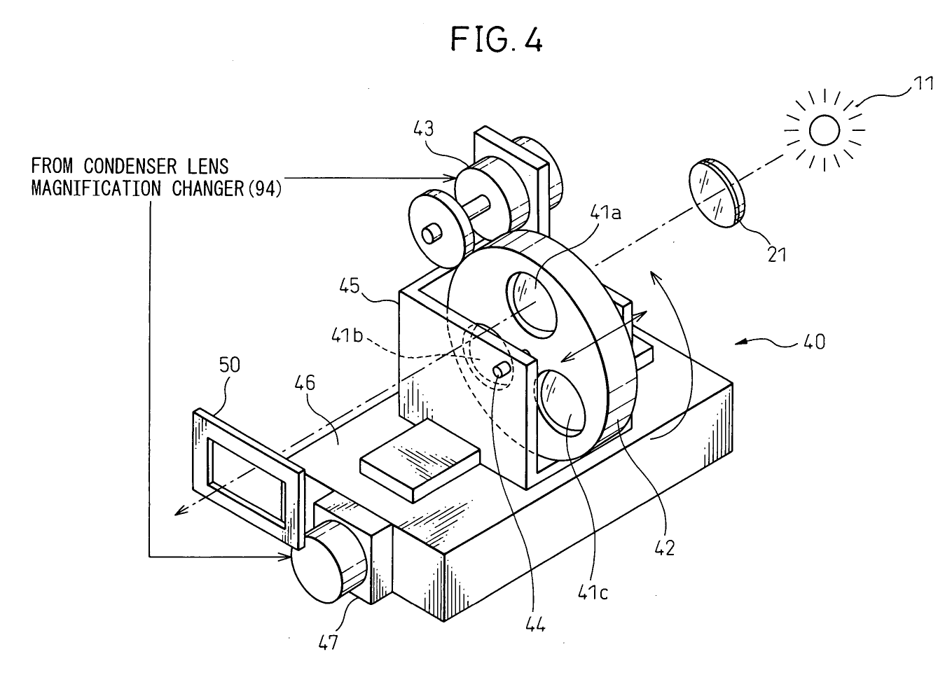

FIG. 4 shows the schematic configuration of the condenser lens mechanism 40 switching the magnification in accordance with the condenser lens magnification changer 94. The condenser lens mechanism 40 is provided with a turret structure provided at a disk 42 able to rotate the lenses 41a to 41c of the different focal distances specified in the above Table 2 about the shaft 44. By operating the motor 43, the rotational position of the disk 52 is controlled. Due to this, the lens among the lenses 41a to 41c specified by the above Table 2 in accordance with the magnification of the imaging optical system 18 is positioned on the optical axis a2 of the illumination light and the focal distance of the condenser lens 40 is switched to any of the focal distances specified above.

Further, the condenser lens mechanism 40 is provided with a housing 45 for pivotally fastening a shaft 44 and fastening a motor 43, a linear motion guide 46 for guiding this housing 45 along the optical axis a2, and a motor 47 for driving the housing 45 along the linear motion guide 46. The condenser lens magnification changer 94 controls the motors 43 and 47 to control the focal distance and position of the condenser lens 40 in accordance with the magnification of the imaging optical system 18 in accordance with the above Table 2 so as to change magnification of the condenser lens 40 in accordance with the magnification of the imaging optical system 18 changed by the observation magnification changer 91.

Note that in the above embodiment, a field aperture with variable aperture dimensions was provided at the position of the field aperture 30, but when providing a condenser lens magnification changer 94 changing the magnification of the condenser lens 40 in accordance with the magnification of the imaging optical system 18 and the condenser lens mechanism 40 shown in FIG. 4, it is also possible to provide an aperture of fixed dimensions (long side 5.2 mm×short side 2.2 mm) at the position of the field aperture 31. Further, if allowing eclipse by the field aperture 30 accompanying change of the observation magnification, it is also possible change the illumination range by just the field aperture dimension changer 93 and the field aperture mechanism 30 shown in FIG. 3 and not provide the condenser lens magnification changer 94 and the condenser lens mechanism 40 shown in FIG. 4.

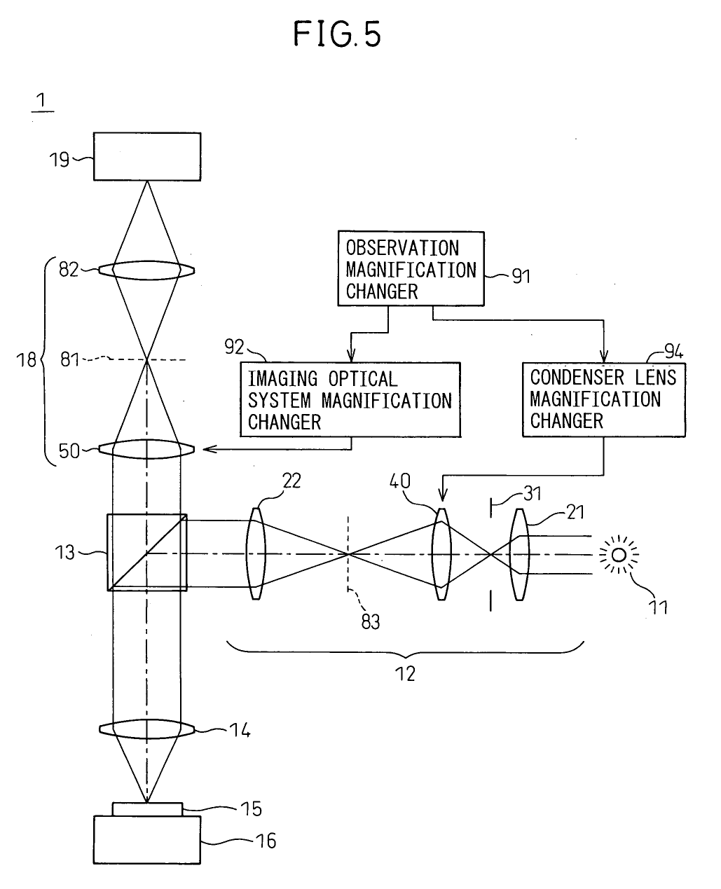

The illumination optical system 12 and the imaging optical system 18 of the optical inspection system shown in FIG. 1 may be made a confocal optical system. For example, as shown by the schematic configuration of the optical inspection system according to the second embodiment of the present invention shown in FIG. 5, the optical inspection system 1 may provide a pinhole array 81 at the light receiving surface of the imaging device 19 in the optical inspection system shown in FIG. 1, that is, the back focal position of the imaging lens 50, and further provide a pinhole array 83 at the conjugated plane at the position of the pinhole array 81, that is, the front focal position of the relay lens 22, so as to make the illumination optical system 12 and the imaging optical system 18 a confocal optical system.

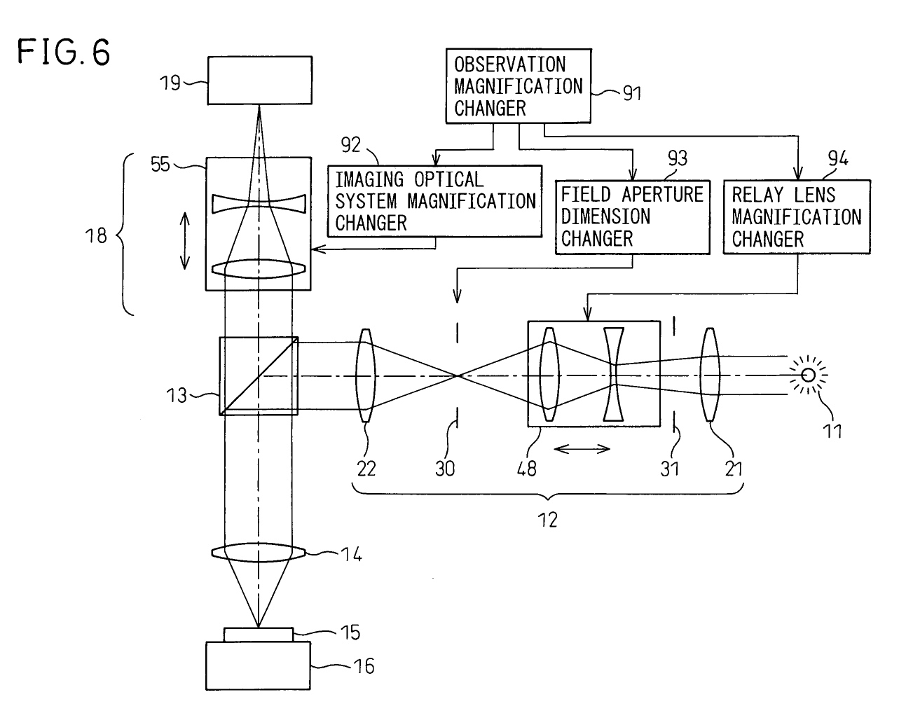

FIG. 6 is a schematic view of the configuration of an optical inspection system according to a third embodiment of the present invention. In the present embodiment, the condenser lens 40 shown in FIG. 1 is replaced with the relay lens 48 of the zoom optical system comprised of the two or more groups of lenses. For this relay lens 48, a known zoom optical system able to variably change the magnification without changing the conjugate relationship between the field aperture 30 and field aperture 31 is used. In the present embodiment, the magnification can be variably changed between 5× to 1.5×. Further, the imaging optical system 18 is comprised by a known zoom optical system 55 able to change the focal distance while fixing the back focal position at the light receiving surface of the imaging device 19. In the present embodiment, the imaging optical system 18 can be changed from f=480 to 1600 mm.

If now assuming the diameter of the beam of the illumination light at the field aperture 31 to be 6.6 mm and the magnification of the relay lens 48 to be 5×, the diameter of the beam at the field aperture 30 becomes 33 mm. Further, if setting the focal distance of the zoom optical system 55 to f=480 mm or substantially the same as the focal distance of the relay lens 22 (f=500 mm), the field aperture 30 and the light receiving surface of the imaging device 19 become substantially equal magnification conjugate planes. If using a light receiving surface of the imaging device 19 in the present embodiment having as dimensions a long side of 30 mm×short side of 12 mm (diagonal length 32.24), if making the aperture dimensions of the field aperture 30 substantially the same dimensions (for example, assuming some leeway, 31 mm×13 mm), the illumination light from the relay lens 48 passes through all positions in the aperture of the field aperture 30, so the sample 15 can be illuminated substantially without excess or shortage.

The optical inspection system 1 has a relay lens magnification changer 94 changing the magnification of the relay lens 48 to change the cross-sectional dimensions of the beam of the illumination light at the position of its back focal position, that is, the field aperture 30, in accordance with the observation magnification changer 91 changing the focal distance of the zoom optical system 55 of the imaging optical system 18 to change the observation magnification. By having the relay lens magnification changer 94 change the magnification of the relay lens 48 in accordance with the focal distance of the zoom optical system 55 of the imaging optical system 18, it is possible to illuminate the sample 15 substantially without excess or shortage.

At this time, the field aperture dimension changer 93 may change the dimensions of the field aperture 30 in accordance with the focal distance of the zoom optical system 55 of the imaging optical system 18. When stepwisely changing the magnification of the relay lens 48 and the focal distance of the zoom optical system 55, the structure of the field aperture mechanism may be configured in the same way as in FIG. 3 (change of aperture dimensions). Configuring a field aperture 30 able to steplessly change the aperture dimensions so as to block illumination light without excess or shortage even if steplessly changing the magnification of the relay lens 48 and the focal distance of the zoom optical system 55 is preferable. Further, the field aperture 31 may be made a fixed field aperture having aperture dimensions of 6.2 mm×2.2 mm.

In the above way, if it were possible to continuously (steplessly) change the focal distance of the zoom optical system 55 of the imaging optical system 18 to change the observation magnification continuously, it would be possible to continuously change the size of the examined object captured by 1 pixel of the imaging device 19 (TDI). Here, for example, when observing line-and-space patterns (region of repeated line shaped conductors and spaces between them) of the semiconductor circuit, the size of the examined object captured by 1 pixel is finely adjusted to change the contrast of the image of the patterns, but if the contrast of the patterns rises too much, conversely finding defects in them would become more difficult. Therefore, by continuously changing the size of the examined object captured by 1 pixel to adjust the contrast of the image of the pattern so as to suitably drop, flexible defect inspection becomes possible.

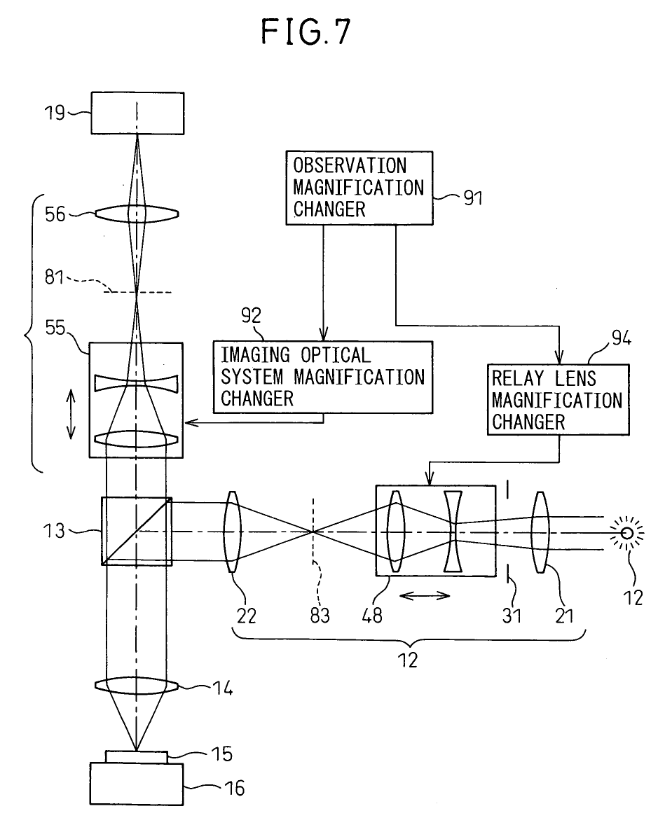

Further, the optical inspection system 1 shown in FIG. 6 as well may provide a pinhole array 81 at the light receiving surface of the imaging device 19, that is, the back focal position of the zoom optical system 55, and may provide a pinhole array 83 at the conjugated plane of the position of the pinhole array 81, that is, the front focal position of the relay lens 22, so as to make the illumination optical system 12 and the imaging optical system 18 a confocal optical system. This configuration is shown in FIG. 7.

The above embodiments achieve the object of the present invention of illuminating exactly the necessary and sufficient region on the sample 15, but to change the observation magnification, the illumination numerical aperture (illumination NA) ends up fluctuating. When using the Koehler illumination like in the present invention, if the illumination NA changes, the coherence changes and due to this, the resolution, depth of focus, and contrast are affected. On the other hand, the optimal illumination NA differs depending on the observed object, so the inspection system is preferably configured so as to change the aperture NA. Therefore, in the following embodiments, a configuration is realized enabling the size of the illumination area to be changed in accordance with the magnification of the imaging optical system and enabling the illumination NA to be changed independently from the size of the illumination area.

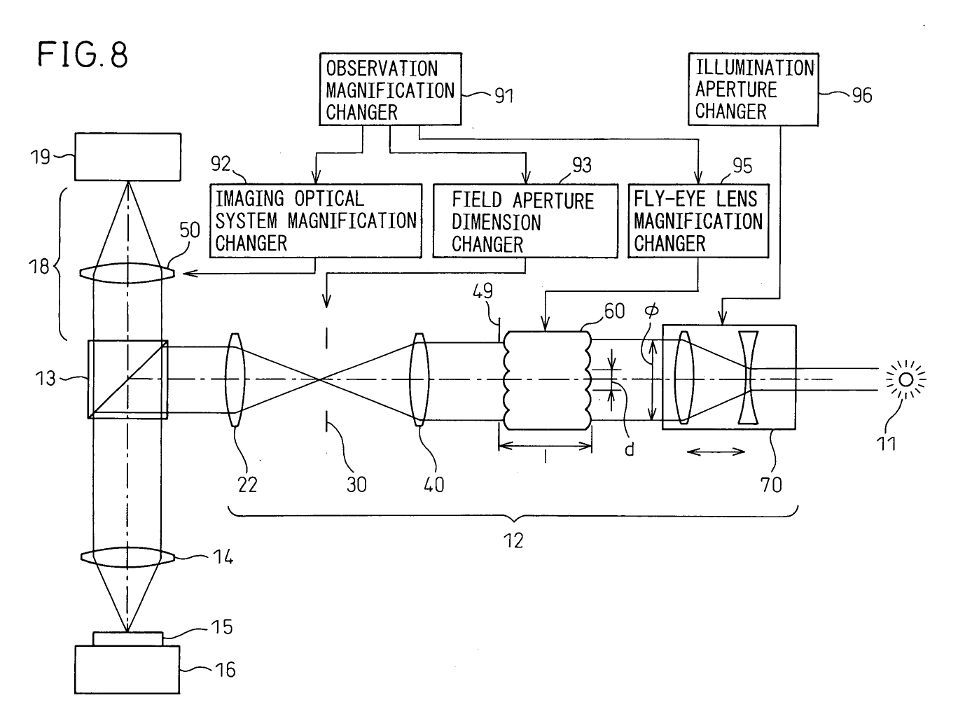

FIG. 8 is a schematic view of the configuration of the optical inspection system according to a fifth embodiment of the present invention. In the optical inspection system 1, the illumination optical system 12, like the optical inspection system shown in FIG. 1, is provided with a relay lens 22 and condenser lens 40 and further is provided with a fly-eye lens 60 and beam expander 70 in that order at the front side from the condenser lens 40 (light source 11 side). Further, in the present embodiment, as the light source 11, a laser light source of deep ultraviolet (DUV) light using a solid-state laser having a wavelength of about 210 nm is used. The imaging optical system 18 is configured in the same way as the optical inspection system in FIG. 1, so the same components are assigned the same reference numerals and explanations are omitted.

The illumination light from the light source 11 passes through the beam expander 70, fly-eye lens 60, and condenser lens 40 and is gathered at the position of the field aperture 30. The focal distance of the relay lens 22 is, like the optical inspection system of FIG. 1, 500 mm, while the position of the field aperture 30 is the front focal distance of the relay lens 22. For this reason, the image of the field aperture 30 is projected infinitely by the relay lens 22, is reflected to the object lens 14 by the beam splitter 13, then is gathered at to the sample 15 by the object lens 14, and the position of the field aperture 30 and the surface of the sample become conjugate planes. The focal distance of the object lens 14, like the optical inspection system of FIG. 1, is 10 mm, so the magnification due to the relay lens 22 and object lens 14 becomes 500 mm/10 mm=50×.

The light reflected from the sample 15 passes through the object lens 14 again, passes through the beam splitter 13, and reaches the imaging lens unit 50. Like the optical inspection system of FIG. 1, the imaging lens unit 50 is provided switchably with imaging lenses 51a to 51c having focal distances of 500 mm, 1000 mm, and 2000 mm (see FIG. 2). For this reason, the observation magnification of the imaging lens unit 50 and object lens 14 can be switched to 50×, 100×, and 200×. The observation magnification changer 91 positions one of these imaging lenses 51a to 51c at the position of the optical axis of the object lens 14 through the imaging optical system magnification changer 92 to switch the focal distance (magnification) of the imaging lens unit 50 and change the magnification of the imaging optical system 18.

Note that the object lens 14 in the present embodiment is a lens having an NA (that is, NAo)=0.9 for obtaining a sufficient resolution. Further, for the imaging device 19, in the same way as the optical inspection system of FIG. 1, a TDI sensor is used. The light receiving surface has dimensions of a long side of 40 mm×short side of 12 mm (diagonal length of 41.76 mm). By switching the focal distance of the imaging lens unit to 50 to 500 mm, 1000 mm, and 2000 mm, the ratio of the observation magnification due to the imaging lens unit 50 and object lens 14 with respect to the projection magnification of due to the relay lens 22 and object lens 14 changes to equal magnification, 2×, and 4×. Therefore, the field aperture dimension changer 93 changes the aperture dimensions of the field aperture 30 in accordance with the magnification of the imaging optical system 18 (that is, which of the imaging lenses 51a to 51c is used) in accordance with the following Table 3. The numerical values shown in Table 3 are numerical values given some leeway considering the fine fluctuations in magnification of the optical system and the margin for lens adjustment.

TABLE 3

| Focal distance of | Aperture dimensions (mm) of field aperture | |
|---|---|---|
| imaging lens (mm) | Long side | Short side |
| 500 | 41 | 13 |
| 1000 | 20.5 | 6.5 |
| 2000 | 10.25 | 3.25 |

Below, the optical configuration from the light source 11 to the position of the field aperture 30 will be explained. The beam expander 70 enlarges the illumination light (laser beam) having a diameter of about 2 mm at the outlet of the light source 11 to a maximum of a diameter of 28 mm or so and converts it to a light beam parallel to the optical axis. The illumination light emitted from the beam expander 70 enters the fly-eye lens 60.

The fly-eye lens 60 is comprised of several to several dozen small unit lenses regularly arranged by being bundled together so that their vertexes are on the same plane. Each of these unit lenses has equal radii of curvature r at the two sides and have vertexes at the two ends forming focal points when introducing parallel light from the opposite sides. Therefore, the focal distance f_{f} is given by the following equation (1):
f_{f}=l=(n−1)*r/n (1)

where,

l is the lens thickness (length) of the fly-eye lens 60,

r is the radius of curvature of each unit lens, and

n is the refractive index.

In the present embodiment, calcium fluoride is used for the glass material, and the refractive index n is about 1.5.

The fly-eye lens 60 is arranged to have a rear side vertex position substantially equal to the aperture position of the condenser lens 40 (front focal position). This being so, the front side vertex plane becomes conjugate with the position of the field aperture 30, and the imaging magnification β is given by the following equation (2):
β=f_{c}/f_{f} (2)

where, f_{c}, is the focal distance of the condenser lens 40

If the beam expander 70 converts the illumination light from the light source 11 to parallel light and it enters the fly-eye lens 60, an image of illumination light of a uniform brightness having a beam of a diameter L given by the following equation (3) is formed at the position of the field aperture 30:
L=βd=f_{c}/f_{f}*d (3)

where, d is the diameter of the aperture of the front side vertex plane of each unit lens of the fly-eye lens 60

As clear from the above equation (3), by changing the focal distance f_{f} of the fly-eye lens 60, it is possible to change the diameter, that is, the cross-sectional dimensions, of the beam of the illumination light appearing at the position of the field aperture 30. Therefore, the optical inspection system 1 is provided with a fly-eye lens magnification changer 95 for changing the magnification of the fly-eye lens 60 in accordance with the magnification of the imaging optical system 18 changed by the observation magnification changer 91 (that is, in accordance with which of the imaging lenses 51a to 51c is used).

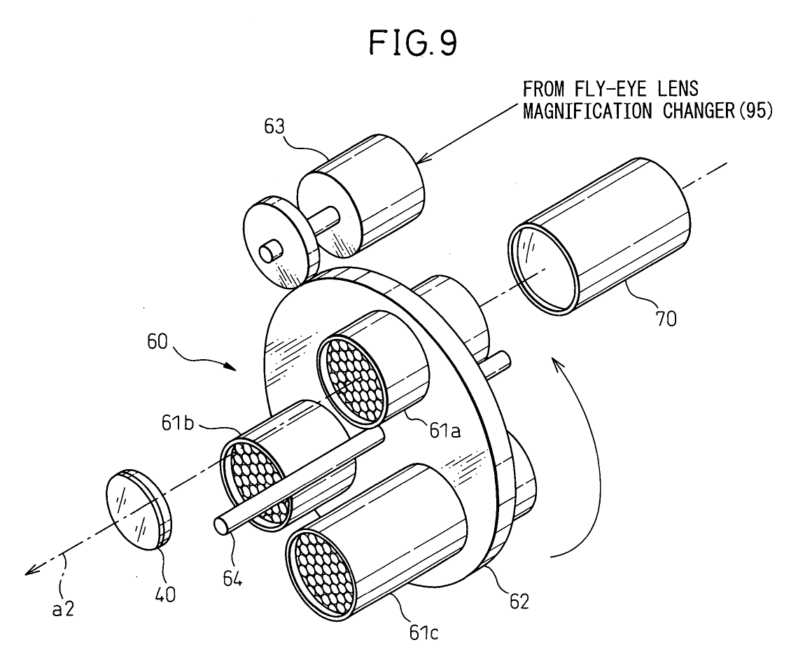

FIG. 9 shows the schematic configuration of a fly-eye lens mechanism 60 for switching the magnification under the control of the fly-eye lens magnification changer 95. The fly-eye lens mechanism 60 has a plurality of fly-eye lenses 61a to 61c having magnifications and dimensions specified in the following Table 4 corresponding to the imaging lenses 51a to 51c. These fly-eye lenses 61a to 61c are provided on a disk 62. By operating the motor 63 and making the disk 62 rotate about the shaft 64 to control the rotational position of the disk 62, the desired lens among the fly-eye lenses 61a to 61c is positioned on the optical axis a2 of the beam expander 70 and the magnification of the fly-eye lens 60 is switched. The fly-eye lens magnification changer 95 controls the motor 63 to control the magnification of the fly-eye lens 60 corresponding to the magnification of the imaging optical system 18 in accordance with the following Table 4.

TABLE 4

| | | | |
|---|---|---|---|
| Focal distance of imaging lens (mm) | 500 | 100 | 200 |
| Focal distance of fly-eye lens (mm) | 100 | 160 | 200 |
| Radius of curvature (mm) | 300 | 480 | 600 |
| Long side of unit lens (mm) | 5 | 4 | 3 |
| Short side of unit lens (mm) | 1.5 | 1.2 | 0.9 |
| L1 (mm) | 40 | 20 | 10 |
| L2 (mm) | 12 | 6 | 3 |

As shown in Table 4, the fly-eye lens 60 used in the present embodiment, when seen from the optical axis, has unit lenses of rectangular shapes with different long sides and short sides. This ratio is designed to be substantially equal to the aspect ratio of the light receiving surface of the imaging device 19 (TDI sensor). The long side dimension L1 and short side dimension L2 of the cross-section of the beam of the illumination light gathered at the position of the field aperture 30 by each of the fly-eye lenses 61a to 61c are shown together in the above Table 4.

On the other hand, the illumination numerical aperture NAi of the beam when the illumination light enters the field aperture 30 is determined by the following equation (4) from the diameter φ of the beam exiting from the beam expander 70:
NAi=φ/2f_{c} (4)

Here, if the focal distance f_{c} of the condenser lens 40 is made 800 mm and the diameter φ of the beam when leaving the beam expander 70 is a maximum 28 mm, the illumination numerical aperture NAi can be made
NAi=28/ 2/800=0.0175

This numerical aperture becomes NAi=0.875 through the relay lens 22 and object lens 14. Therefore, it becomes possible to secure at a maximum an illumination NA with a coherence σ of 0.972.

In the embodiment shown in FIG. 8, the beam expander 70 is configured as a zoom optical system able to move two or more groups of lenses to continuously change the diameter φ of the beam of the parallel light exiting the beam expander 70. The optical inspection system 1 is provided with an illumination aperture changer 96 for controlling the zoom magnification of the zoom optical system of the beam expander 70 so as to change the diameter φ of the beam of the parallel light exiting from the beam expander 70 and entering the fly-eye lens 60 and thereby change the above illumination numerical aperture NAi. By changing the illumination numerical aperture by changing the diameter φ of the beam of the parallel light entering the fly-eye lens 60 in this way, it becomes possible to adjust the illumination numerical aperture independently from a change of the illumination range accompanying a change of the observation magnification.

Further, when switching the observation magnification, if switching the lenses 51a to 51c of the imaging lens unit 50 to switch the focal distance and switching the magnification of the fly-eye lens 60 in accordance with this, it is possible to switch only the observation magnification without changing the illumination NA much at all.

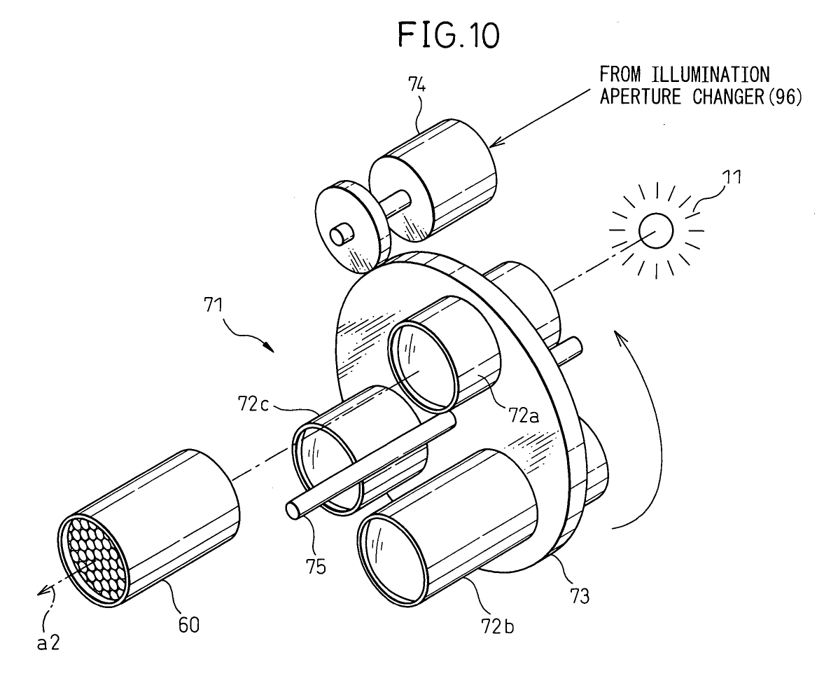

In the embodiment shown in FIG. 8, the beam expander 70 was configured as a zoom optical system, but it is also possible instead of this to provide a plurality of beam expanders with different zoom magnifications and switch these to stepwisely change the diameter φ of the beam of the illumination light entering the fly-eye lens 60. For this reason, as shown in FIG. 10, it is also possible to provide a beam expander mechanism 71 for switching the zoom magnification of the beam expander under the control of the illumination aperture changer 96. The beam expander mechanism 71 has a disk 73 provided with a plurality of beam expanders 72a to 72c with different zoom magnifications. This operates a motor 74 under the control of the illumination aperture changer 96 to rotate the disk 73 about a shaft 75 and switch one of the beam expanders 72a to 72c positioned on the optical axis a2 so as to switch the zoom magnification.

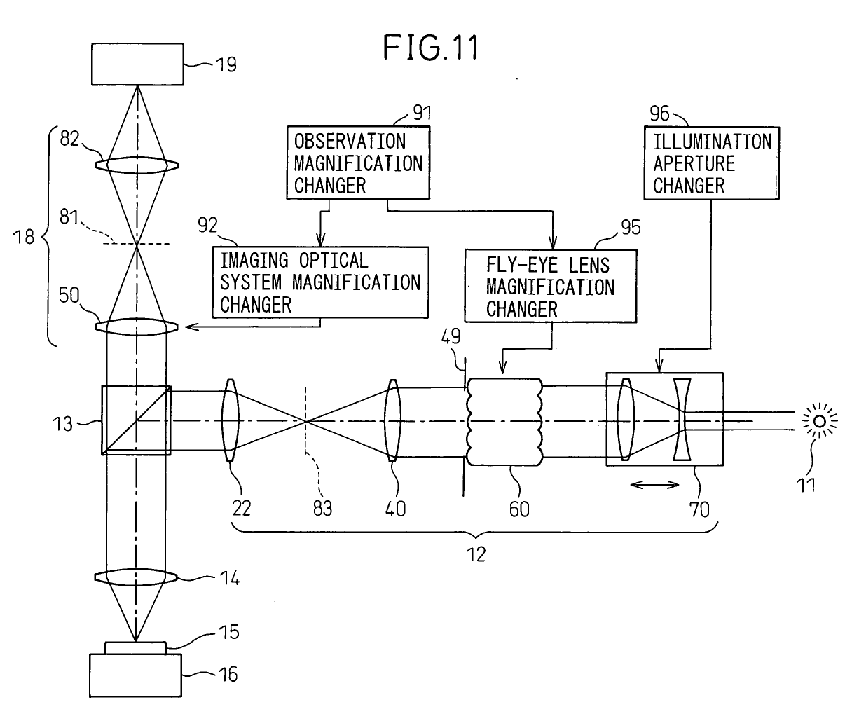

Further, the optical inspection system 1 shown in FIG. 8 may provide a pinhole array 81 at the light receiving surface of the imaging device 19, that is, the back focal position of the imaging lens 50, and may provide a pinhole array 83 at the conjugated plane of the position of the pinhole array 81, that is, the front focal position of the relay lens 22, to make the illumination optical system 12 and the imaging optical system 18 a confocal optical system. This configuration is shown in FIG. 11.

The present invention can be utilized for an optical inspection system and illumination method used for inspection of wafers, masks, or other semiconductor materials, more particularly can be utilized for an optical inspection system and illumination method using deep ultraviolet light as illumination light.

While the invention has been described with reference to specific embodiments chosen for purpose of illustration, it should be apparent that numerous modifications could be made thereto by those skilled in the art without departing from the basic concept and scope of the invention.

1. An optical inspection system provided with a light source, an object lens, an illumination optical system for emitting illumination light generated from a light source through the object lens onto a sample, and an imaging optical system for forming an image of a sample projected by the object lens,
said optical inspection system further provided with
an imaging optical system magnification changer which changes the magnification of the imaging optical system and
an illumination light cross-sectional dimension changer provided at the illumination optical system and changing the cross-sectional dimensions of the illumination light emitted to the sample in accordance with the magnification of the imaging optical system.

2. An optical inspection system as set forth in claim 1, wherein:
the illumination optical system is provided with a condenser lens for gathering the illumination light from the light source and forming an image of the light source on the pupil plane of the object lens and
the illumination light cross-sectional dimension changer changes the magnification of the condenser lens to change the cross-sectional dimensions of the illumination light.

3. An optical inspection system as set forth in claim 1, wherein the illumination light cross-sectional dimension changer is provided with a fly-eye lens provided at the illumination optical system and changes the magnification of the fly-eye lens to change the cross-sectional dimensions of the illumination light.

4. An optical inspection system as set forth in claim 1, wherein
the illumination optical system is provided with a condenser lens for gathering the illumination light from the light source and forming an image of the light source on the pupil plane of the object lens and
the illumination light cross-sectional dimension changer is provided with a relay optical system arranged between the light source and the condenser lens and changes the magnification of the relay optical system to change the cross-sectional dimensions of the illumination light.

5. An optical inspection system as set forth in claim 4, wherein the illumination light cross-sectional dimension changer is provided with a fly-eye lens provided at the illumination optical system and changes the magnification of the fly-eye lens to change the cross-sectional dimensions of the illumination light.

6. An optical inspection system as set forth in claim 1, wherein
the illumination optical system is provided with a condenser lens for gathering illumination light from the light source to form an image of the light source on the pupil plane of the object lens and an illumination numerical aperture changer which changes the cross-sectional dimensions of the illumination light entering the condenser lens to change the illumination numerical aperture,
the illumination light cross-sectional dimension changer is provided with a fly-eye lens arranged between the light source and condenser lens and changes the magnification of the fly-eye lens to change the cross-sectional dimensions of the illumination light, and
the illumination numerical aperture changer is provided with a relay optical system arranged between the light source and fly-eye lens and changes the magnification of the relay optical system to change the illumination numerical aperture.

7. An optical inspection system as set forth in claim 1, wherein the illumination light cross-sectional dimension changer is provided with a field aperture provided at the illumination optical system and changes the aperture dimensions of the field aperture so as to change the cross-sectional dimensions of the illumination light.

8. An optical inspection system as set forth in claim 1, wherein said illumination optical system and said imaging optical system form a confocal optical system.

9. An illumination method of an optical inspection system provided with a light source, object lens, illumination optical system emitting illumination light generated from a light source through an object lens to the sample, and imaging optical system for forming an image of the sample projected by the object lens,
said illumination method changing the cross-sectional dimensions of the illumination light in an illumination optical system in accordance with the magnification of the imaging optical system so as to adjust the illumination range on the sample.

10. An illumination method of an optical inspection system as set forth in claim 9, wherein
the illumination optical system is provided with a condenser lens for gathering the illumination light from the light source to form an image of the light source on the pupil plane of the object lens and
changes the magnification of the condenser lens so as to change the cross-sectional dimensions of the illumination light.

11. An illumination method as set forth in claim 9, wherein
the illumination optical system is provided with a fly-eye lens and
changes the magnification of the fly-eye lens so as to change the cross-sectional dimensions of the illumination light.

12. An illumination method of an optical inspection system as set forth in claim 9, wherein
the illumination optical system is provided with a condenser lens for gathering the illumination light from the light source to form an image of the light source on the pupil plane of the object lens and a relay optical system arranged between the light source and condenser lens and
changes the magnification of the relay optical system to change the cross-sectional dimensions of the illumination light.

13. An illumination method of an optical inspection system as set forth in claim 12, wherein
the illumination optical system is provided with a fly-eye lens and
changes the magnification of the fly-eye lens so as to change the cross-sectional dimensions of the illumination light.

14. An illumination method of an optical inspection system as set forth in claim 9, wherein
the illumination optical system is provided with a condenser lens for gathering the illumination light from the light source to form an image of the light source on the pupil plane of the object lens, a fly-eye lens arranged between a light source and condenser lens, and relay system arranged between the light source and fly-eye lens and
changes the magnification of the fly-eye lens so as to change the cross-sectional dimensions of the illumination light and
changes the magnification of the relay optical system to change the cross-sectional dimensions of the illumination light entering the condenser lens so as to change the illumination numerical aperture.

15. An illumination method of an optical inspection system as set forth in claim 9, wherein
the illumination light system is provided with a field aperture and
changes the aperture dimensions of the field aperture so as to change the cross-sectional dimensions of the illumination light.

16. An illumination method as set forth in claim 9, wherein said illumination optical system and said imaging optical system form a confocal optical system.
